(19) United States
(12) Patent Application Publication
(10) Pub. No.: US 2023/0321919 A1
(43) Pub. Date: Oct. 12, 2023

(54) Electronics Module to support 3D printers enabling a Production Network

(71) Applicant: INDUSTRY SUPPLIES, INC., Newark, DE (US)

(72) Inventor: Martin D. Fiumura, Buenos Aires (AR)

(21) Appl. No.: 18/297,060

(22) Filed: Apr. 7, 2023

Related U.S. Application Data
(60) Provisional application No. 63/328,573, filed on Apr. 7, 2022.

(51) Int. Cl. B29C 64/393; B29C 64/20; B33Y 50/02; B33Y 30/00

(52) U.S. Cl. CPC B29C 64/393; B29C 64/20; B33Y 50/02; B33Y 30/00

(57) ABSTRACT

Method and apparatus for a Production Network used in Additive Manufacturing and, more particularly, a Single Print Unit and a Print Array of additive manufacturing Print Units using the same Electronics Modules to enable a scalable Production Network with no downtime thanks to interchangeable modules and centralized control.

### FIELD OF THE INVENTION

This invention relates to a 3D additive manufacturing system's Array. The Print Array architecture is devised to support and manage scalable part production by deploying modular and interchangeable control electronics for each Print Unit module.

### BACKGROUND OF THE INVENTION

Over the decades, additive manufacturing (AM) has matured into a reliable technology with a great variety of equipment and advanced software options. Faster machines, better materials, and smarter software are helping to make AM a realistic solution for many real-world production applications. As processes have matured and materials science has accelerated, additive manufacturing is now used throughout the full production cycle complementing traditional manufacturing processes.

AM technology is now proven, well-understood and established as a manufacturing method across many industry sectors. The key standards have been developed, enabling repeatable quality at scale. AM systems offer several benefits, including increased flexibility, independence, as well as time and cost savings.

Industrial 3D printing systems have been developed as complex technical equipment, which requires technical training to develop practical operation and maintenance skills. Taking into consideration the organization's need for early-stage adoption and scalability, the present invention aims at making more efficient operation, maintenance, technical services to 3D printing systems so to reduce downtime, and thus maintenance and training costs.

The main obstacle preventing the adoption of 3D printers into an industrial manufacturing process is the lack of a workflow from prototyping to scalable production. In fact, companies use 3D printers as stand-alone equipment in which they prototype and also manufacture the final parts they need in low volume batches. A target company may purchase a few units to cover the production needs by operating each unit individually.

On one side, the R&D team requires the agility to iterate prototypes and finalize the design for each component. On the other side, the procurement team has to develop the supply chain, and thus determine whether to convert the designs onto another manufacturing process (with great cost and lead time) or, if manufacturing with 3D printers is possible for that application, to purchase more 3D printers to meet the production needs. No 3D printer product line offers a real solution to solve both the needs of the R&D team and those of procurement.

Providing a path to an additive manufacturing Production Network requires hardware, electronics, control protocols and software. This patent covers the interface between the Print Array Host and the Electronics Module.

### SUMMARY OF THE INVENTION

Process development is based on the system architecture of the 3D printer being used. The critical machine elements are the XY motion system, hotend, nozzle geometry, filament drive system, chamber heating, and filament drying. Related variables material type and size are either determined by the machine requirements.

The current state-of-the-art Stratasys FDM systems are typical. On one hand, the F370 prototyping system is based on MakerBot technology, has limited materials, and is priced for departmental use at less than $50,000. On the other hand, their industrial model Fortus 450MC is based on older Stratasys technology and has a more extensive range of materials and is priced at around $160,000-220,000.

The issue with the use of these machines is that they share very little in architecture; like they were created by different companies. An engineer creating functional prototypes on the F370 has to redo that development effort on the production machine to scale.

These are all impediments to the creation of a true digital workflow. The node-based 3D printing is a structural difference, that requires a new control protocol and results in a network-based production: the Production Network.

Interoperability at this level enables not just distributed control of a machine, but distributed production.

The interface design from the Print Array Host to the Electronics Module is both unique and protectable. The separation of control electronics makes these modular and interchangeable. The swappable and interchangeable architecture forces a separation of the print unit and control electronics. This will increase economies of scale and help create a de facto standard. The common logical interface enforced this way also opens up generic APIs to address and control network printers.

The interface between the Electronics Module and the Print Array Host controls are well defined so that other Print Unit types could include both additive, traditional manufacturing, inspection, and scanning technologies.

This marketplace for Print Unit modules creates a Production Network and the network marketing effect.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 is a perspective view of a Print Array unit featuring one-to-one matchup of Electronics Module (2) to Print Unit (1) and Feeding and Drying Module (3) in accordance with the present invention.

FIG. 2 is a perspective view of a Single Print Unit for prototyping in accordance with the present invention.

FIG. 3 is a perspective view of a Print Unit Module within a Single Print Unit (FIG. 2) featuring an integrated Electronics Module (4) in accordance with the present invention.

FIG. 4 is a perspective view of a Print Unit Module of the Print Array (FIG. 1) in accordance with the present invention.

FIG. 5 is a perspective view of a Feeding System up to the extruders in the Print Unit featuring 2 Buffers (8), electronics (7) and a Drying Module (6) in accordance with the present invention.

FIG. 6 is a front view of a Print Array Host featuring all 2×4 Buffers (9), a Feeding and Drying Module (10) in accordance with the present invention.

FIG. 7a and FIG. 7b are perspective views of the Electronics Module featuring service display (11), a pull-out handle (13), and two keying elements (12) on the bottom panel of the cabinet in accordance with the present invention.

FIG. 8 is a front view of a Print Unit adjacent to an Electronics Module featuring keying elements (14) fitting into the T-slotted aluminum profiles on the Print Array Host in accordance with the present invention.

FIG. 9 is a perspective front view of a Print Unit and its associated Electronics Module in the Print Array Host in accordance with the present invention.

FIG. 10 is a perspective of the rear panel of an Electronics Module featuring industrial 108-pin heavy duty connector (16) and a power plug (15) in accordance with the present invention.

FIG. 11 is a lateral view of an Electronics Module without a lateral panel showing the electronics architecture inside, including a Control Hardware Mainboard (CHM) (17), a Single Board Computer (SBC) (19), a Built-In Power Supply (20), a keying electrical connector (18) in accordance with the present invention.

FIG. 12 is a perspective view of a Print Array Host featuring a switch (23), an internal Router (24), a CPU (22), and a Power Distribution Board (21) in accordance with the present invention.

### DETAILED DESCRIPTION OF THE INVENTION

### Definitions

| | |
|---|---|
| PU or Print Unit | Print Unit or the modular 3D printing module. |
| | Also, a measure of production capacity (e.g. |
| | a Prototyping Unit = 1 PU; a Production |
| | Machine = 4 PUs) |
| SPU or Single Print Unit | Prototyping Unit |
| PA or Print Array | Production Machine or PM |
| PAH or Print Array Host | Empty Production Machine, no PUs or EMs |
| EM | Electronics Module |
| PN | Production Network or network that these |
| | various print capabilities use for communica- |
| | tions and control |
| Node | A generic print node connected a Prototyping |
| | Unit or Production Machine attached to a |
| | Production Network |
| DRM | Digital Rights Management |
| Control CPU | Central non-real-time controller that manages a |
| | PA. SPUs do not have a Control CPU. |

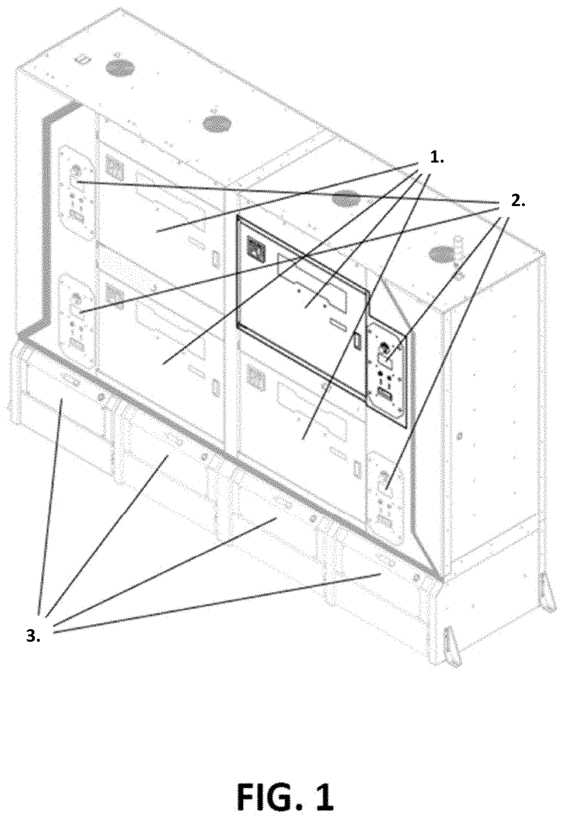

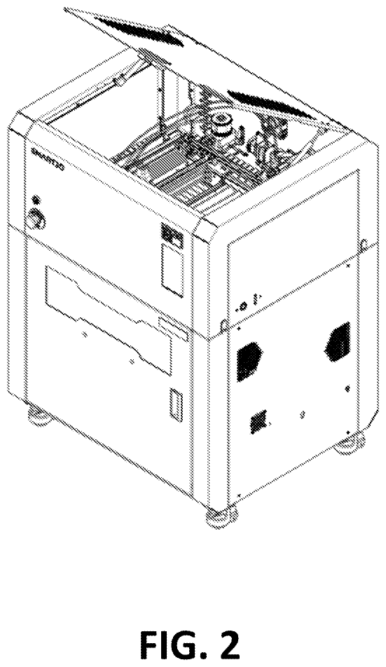

The systems of the present invention were designed for different users, spaces and applications for additive manufacturing. The Single Print Unit (FIG. 2) is a prototyping machine to be used by a designer or engineer at an office to rapidly iterate on the different stages of product development. The Print Array (FIG. 1), on the other hand, is a production machine meant for the manufacturing of tools, fixtures and end-use parts, among others, typically on the factory floor.

These users and setups have different needs. While a designer at an office may see material drying, print queuing, on-screen slicing, automatic material backup and others as “nice-to-have” features, for a production engineer running a batch of hundreds or thousands of parts at a factory they significantly lower labor, downtime, and risk of failure.

For prototyping and first adoption, Single Print Unit (SPU) (FIG. 2) is a self-standing equipment. The Print Array system (Production Machine) (FIG. 1) is a fundamental structure populated with interchangeable modules. In the present invention, Production Machines (PM) are Print Array (FIG. 1) systems in 2×2 or larger arrays of Print Units (PU) (FIG. 4), to provide consistent, scalable motion and print control.

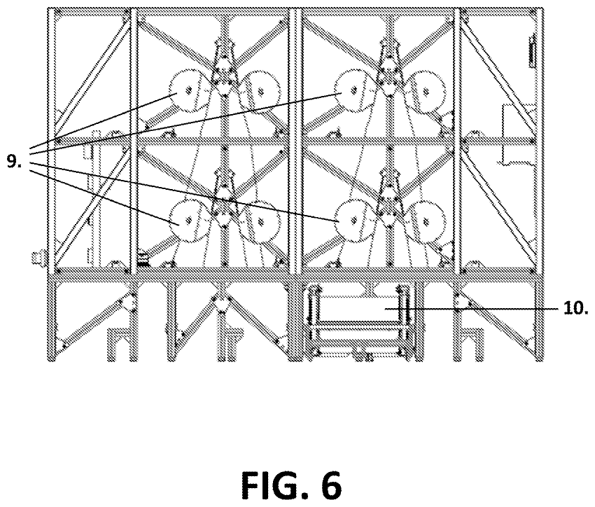

The novelty of the present patent is the modular structure of the Print Unit (FIG. 4) and Print Array (FIG. 1) product line. More specifically, the interface between the Print Array Host (FIG. 6) and the Electronics Modules (2), and the modularity and interchangeability of the Electronics Modules. The new technical modular system of the present invention enables a Production Network using a unique electronics architecture. The Print Array (FIG. 1) system is a fundamental structure populated with modules. The modular architecture gives redundancy to the Production Machine (FIG. 1) in case of failure of one or more modules.

In the preferred embodiment of the present invention, Fused Filament Fabrication (FFF) is the 3D printing technology deployed. In another embodiment, interchangeable modules can include all types of additive manufacturing equipment, as well as traditional manufacturing, inspection and scanning technologies.

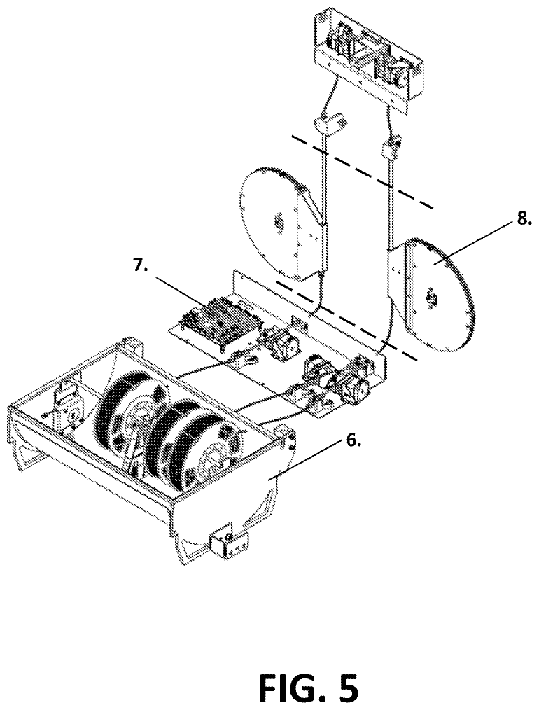

Production Machines (FIG. 1) consist of a sturdy aluminum framing structure, which contains 2×2 modular sets. These sets are composed by 1 Print Unit module (FIG. 4), 1 Electronics module (2), and 1 Feeding system (FIG. 5) with buffers (8). In an embodiment of the present invention, the Production Machine (FIG. 1) includes material Feeding featuring Drying capabilities (6). In another embodiment of the present invention, according to the technology deployed, the Production Machine (FIG. 1) can support other ancillary equipment modules, such as annealing systems, vacuum systems, ultrasonic resin cleaner, support removal systems.

Single Print Units (FIG. 2) are tools for designers and engineers working on different phases in the product life-cycle, such as product development, design iterations, material testing and validation, development and production of manufacturing aids, and spare parts, among others. They enable the creation of a digital inventory, which is the source used at the factory to efficiently select, automate and scale a production process within common material sets and configurations.

These Single Print Units (FIG. 2) are low-cost devices which accelerate the production of each iteration of a prototype, avoid the need for outsourcing with their external quoting requirements and supply chain bottlenecks, reduce lead times, and make every part they process ready for internal production and scale.

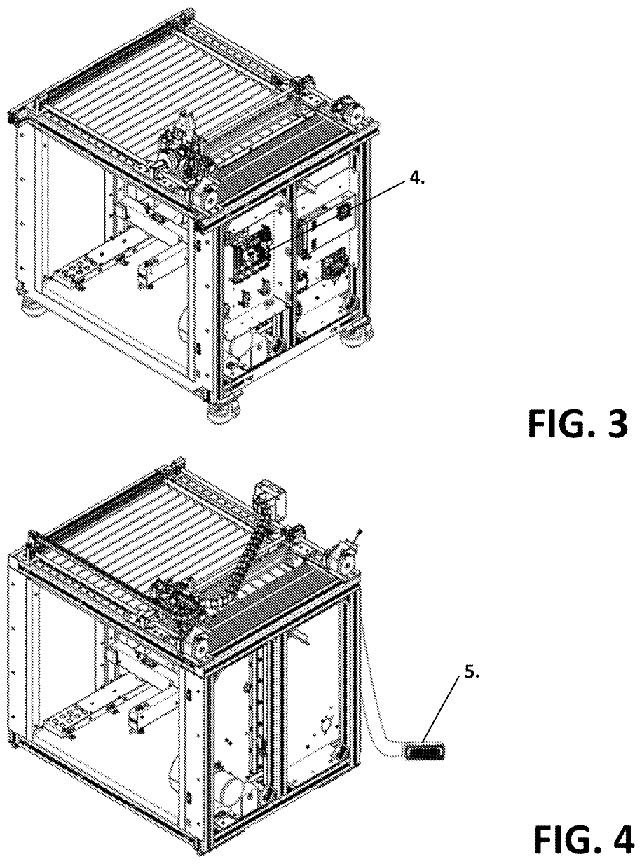

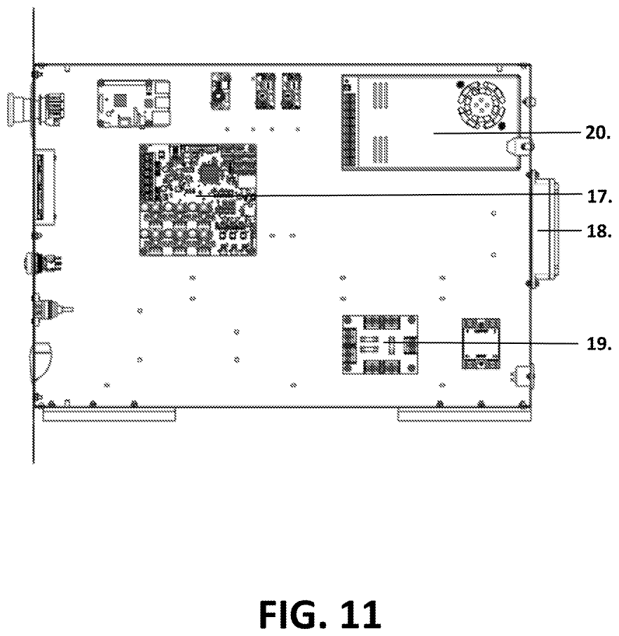

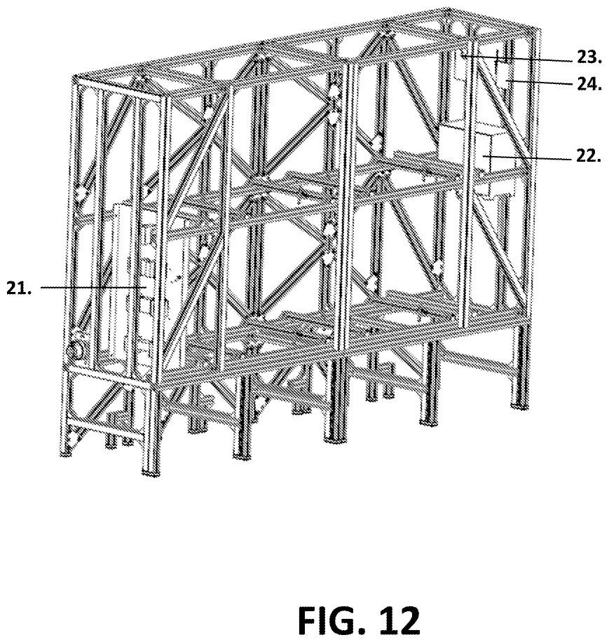

Single Print Units (FIG. 2) have an integrated electronics architecture which is not removable. Single Print Units (FIG. 2) share the same electronics configuration with each Print Unit within the Print Array. The design of the Electronics Module is used both in the Single Print Units (FIG. 3) model used for prototyping and in the Print Array (FIG. 11) product line for production floors.

Single Print Units (FIG. 2) may be a simplified version of the Print Units (FIG. 4) present in Production Machines (FIG. 1). Their core architecture shall not differ, as material compatibility, precision, and speed need to be identical for the transparent transition between prototyping and production. But ancillary features such as material drying, automatic feeding, material backup, Print Unit management or the facilitated replacement of Print Units (1) or Electronics Modules (2) are not required, favoring lower capital investments in the product validation phases of the product lifecycle.

The present invention has a constant, defined quick-change interface at the Electronics Module to the Production Machine and a separate quick-change defined interface from the Print Array to the Print Unit.

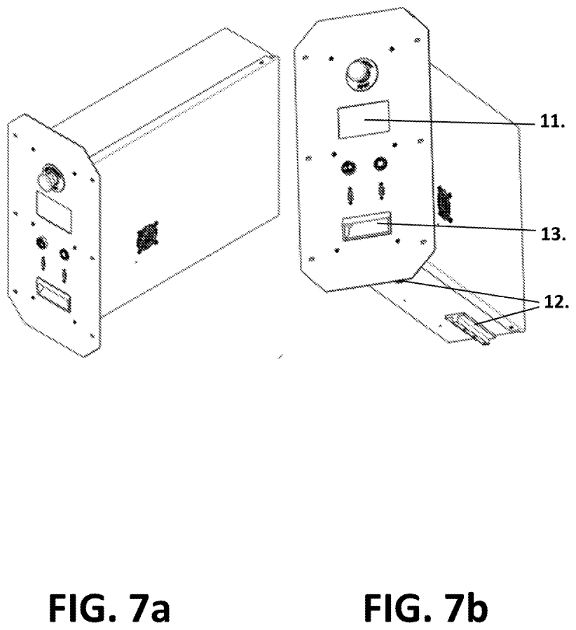

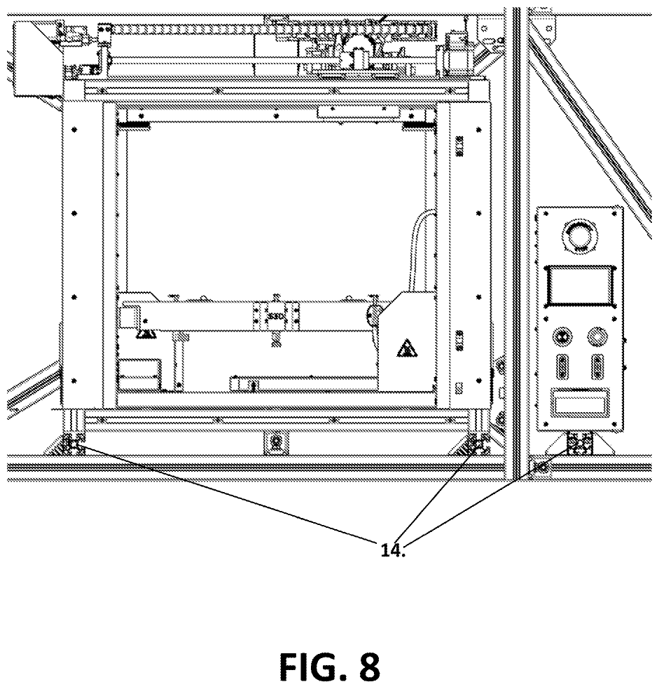

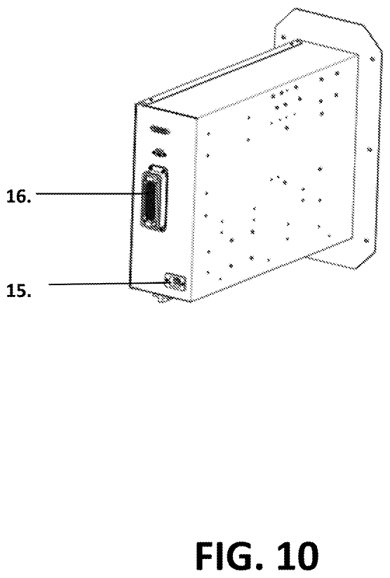

Electronics Modules in the Print Array are modular and slide-out interchangeable subassemblies (FIGS. 7a. FIG. 7b, FIG. 10). Electronics Modules consist of a metal cabinet (FIGS. 7a, 7b, FIG. 10) containing all electronics components of a Print Unit (FIG. 2). The enclosure ensures the operator's security and prevents manipulation of delicate elements.

Each Electronics Module (2) is sized to be easily removed from the Print Array by a single operator by pulling from a handle (11). The interchangeability of all Electronics Modules (2) is required to enable this Production Network and improve uptime. Additionally, serviceability is improved by the quick-change and interchangeable nature of the Electronics Module in the Print Array.

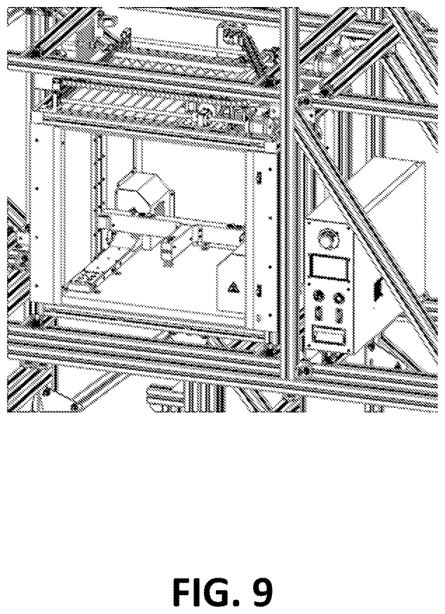

Each Electronics Module (2) is located in proximate distance to the individual Print Unit (FIG. 1 and FIG. 9) and supports all variations and combinations of Print Unit features. Each Electronics Module (2) controls only the Print Unit (1) to which it is associated and physically connected. It only has local computer power resources for print control, to directly control only the Print Unit (1) it is associated with.

Each Print Unit (1) has an Electronics Module (2) associated with it, both in prototyping Single Print Units (FIG. 4) and in production Print Arrays (FIG. 1). Just like motion Print Unit (FIG. 4) elements, these Electronics Modules share the same configuration across the prototyping and the production product lines (4, FIG. 11). And identically to the motion systems, electronics are removable for higher uptime in production setups (FIG. 7a, FIG. 7b) but non-removable in the prototyping line (4).

Each Electronics Module (2) is equipped with a sliding mounting system with blocking clamps on the Print Array Host (FIG. 6). In the preferred embodiment of the present invention, the sliding mounting system consists of keying elements (12) which fit into the T-slotted aluminum profiles (14), allowing modules to slide or roll in and out with ease. Blocking clamps can include screw clamps, spring clamps, strap clamps, bench clamps, or any other means to secure each unit to the Print Array (FIG. 1) structure for security purposes.

The Electronics Module's sliding mounting systems allow EM's to be easily swapped within minutes. This reduces production downtime by rapidly replacing a unit needing maintenance with another one ready for service.

The physical layout of the electrical connections is also a keying element together with its order and arrangement of electrical conductors. The Print Unit (1) module connects to an Electronics Module (2) thanks to a keying element. In the preferred embodiment of the present invention, the keying element is an industrial 108-pin heavy duty male-female connector. The 108-pin connector connects the end of the Print Unit cabling bundle (5) to connector on the rear panel of the Electronics Module (16, 18). This modular architecture allows fast removal with almost no production downtime.

The Electronics Module (2) includes a Built-In Power Supply (20) which connects to the Power Panel (23) within the Print Array (FIG. 1) via a power plug (15) on the rear panel of the electronics cabinet (FIG. 10). The Power Panel (23) within the Print Array Host (FIG. 6) receives and distributes the three-phase power to all Electronics Modules (2), Feeding Systems (3), and CPU (22). The Power Panel (23) contains electrical keys, terminal blocks, and contactors.

All modules within the Production Machine (FIG. 1) can be switched off and disconnected from power individually during maintenance operations. Print Units (1), Electronics Modules (2), Feeding and Drying Systems (3) are interchangeable and can be easily removed individually and replaced. In an embodiment of the present invention, in case of failure of electronics the operator can perform maintenance on each Print Unit (1) from the display on the front panel (23) of each Electronic Module (2) on its side.

The designs to make these modules interchangeable is a fundamental enabler of the Production Network. It allows the ability of fixing or upgrading each component of the system by simply changing the individual module, as well as adapting to user's production needs. This modular architecture provides redundancy as it allows fast removal with almost no production downtime.

Each Electronics Module (2) provides power to one Print Unit's (1) components on module electronics, such as motors, heating system, cooling circuit. It passes through status information and controls switches in the Buffer (8, 9) and material Feeding and Dryer system (FIG. 5, 3). While pushing status information to the Central CPU (22), it provides control and logic signals, as well as providing and receiving data from sensors in the Print Unit (1) and Feeding Systems (FIG. 5, 3).

On a Single Print Unit (FIG. 2) system used for prototyping, the modular electronics unit cabinet (FIG. 3) is integrated within the SPU (FIG. 2). Single Print Units (FIG. 2) do not have a defined interface since they are not quick-change mounted. This direct connection does not change the functionality compared to Print Units (2) in the Production Machine (FIG. 1).

On an SPU (FIG. 2), the Electronics Module (4) is electrically the same as the interchangeable Electronics Module (2, FIG. 11) in the Print Array (FIG. 1) and contains the same components. In the preferred embodiment of the present invention, the Electronics Module includes, among others, a Control Hardware Mainboard (CHM) (17), a Single Board Computer (SBC) (19), a Built-In Power Supply (20), a keying electrical connector (16, 18), and a power plug (15). It also supports RFID, Bluetooth, Bluetooth-LE, IoT interface for logic expansion.

The CHM (17) stores the unit firmware dedicated to movement controls and motor drivers. It also manages all sensors in the Print Unit and up to the filament Buffer (8, 9), such as temperature, proximity, humidity, end-of-filament, or any other supported sensors. It is connected to an SBC (19) and can be controlled directly or over a network.

The SBC (19) provides the user interface via a browser-based control application. It also provides a network interface via the local network or VPN, depending on how it is configured. It processes G-codes and can be programmed for additional networking and third-party program options. It communicates with the CHM (17), provides a webserver for web control, APIs for third-party applications, and a plugin interface specifically for G-code processing plugins. The SBC (19) also stores all offset and calibration values of a Print Unit (1) on a dedicated SD card. Machine performance offsets that are stored with each Single Print Unit are interpreted in the Electronics Module to provide consistent printing performance.

All modules within the Production Machine can be disconnected from power individually during maintenance operations. Print Units, Electronics Modules, Feeding and drying systems are interchangeable and can be easily removed and replaced individually.

The electronics architecture supports future expansions and a wide range of sensors and features. Each Print Unit within the Print Array can support different characteristics. Such variable features include, among others, extrusion and chamber temperature, single or dual extrusion, and insulation for printing a greater variety of engineering and high-performance polymers. The use of the same Electronics Module (2) to support variations of print modules provides consistency and code compatibility, as the same parameters are used on the same module across different platforms. It also provides network control and security. Security protocols with the Cloud/Local Host and data collection generated from the production workflow are handled by the Central CPU (22) in the Production Machine (FIG. 1).

The Electronics Module (2) can be designed to provide control for a wide range of machines, including but not only 3D printers, CNCs, laser cutters, and traditional manufacturing equipment. The electronics architecture of the present invention allows maximum flexibility of machine design through highly capable mainboards, expansion boards, smart tool boards and custom expansion modules which can be included within the Electronics Module (2) as needed.

In the preferred embodiment of the present invention, the Production Machine (FIG. 1) has a built-in Router (24). The internal router connects to Electronics Modules (2), as well as material Feeding and Drying Systems (3) in the Print Array (FIG. 1).

The Internal Router (24) can be configured to connect to an external NAT server, router, or switch. The Production Machine Router (24) supports either static or dynamic IP address configurations for each module. The Production Machine (FIG. 1) is connected to the user's network via LAN, Ethernet, or Wi-Fi, according to local security requirements.

Once connected, all modules in the Print Array Host (FIG. 6) can be operated and visualized via remote connection via IP or local host. Each module self-identifies on this Production Network as an individual addressable and controllable print node. Thanks to the logical interface handshake protocol, this node-based 3D printing creates a new control protocol and sets the foundations for a network-based production, based on a true digital workflow.

The Electronics Module (3) sets global address and type for network and reads nozzle size for the Print Unit (1), material type from the material feeding system, and Print Unit's performance offsets. The common logical interface enforced this way also opens up generic APIs to address and control network printers. When a Print Unit (1) requires maintenance, the module is removed from the Print Array (FIG. 1) together with its dedicated SD card containing its offset and calibration data.

The interface between the Print Array Host and the modular and interchangeable Electronics Modules improves serviceability and uptime, which are crucial for scaling up manufacturing. The distributed control grants maximum flexibility to manage both additive and traditional manufacturing, inspection, and scanning technologies. The modular architecture allows economies of scale, by reducing the cost of both production and prototyping modules. This eliminates the gap to adopt and scale up additive manufacturing in high-volume industrial environments, as factories can simply add Production Arrays (FIG. 1) their Print Units (1) to rapidly meet their growing production demand.

The foregoing describes the preferred embodiment of the invention and sets forth the best mode contemplated for carrying out the invention in such terms as to facilitate the practice of the invention by a person of ordinary skill in the art. However, it is to be understood that the invention has many aspects, is not limited to the structure, processes, methods, and embodiment disclosed and/or claimed, and that equivalents to the disclosed structure, processes, methods, embodiment, and claims are within the scope of the invention as defined by the claims appended hereto or added subsequently.

Although the present invention has been described herein with reference to the foregoing exemplary embodiment, this embodiment does not serve to limit the scope of the present invention. Accordingly, those skilled in the art to which the present invention pertains will appreciate that various modifications and equivalents are possible, without departing from the technical spirit of the present invention.

The embodiments of the invention in which an exclusive property or privilege is claimed are defined as follows:

1. An industrial 3D printing device enabling a scalable Production Network having:
a unique electronics architecture shared with both Single Print Units for prototyping and Print Arrays for production;
modular electronics elements which are electrically and electronically the same in Single Print Units for prototyping as in Print Arrays for production.

2. The apparatus according to claim 1, wherein each Electronics Module is arranged next to an individual Print Unit in 2×2 or larger arrays.

3. The apparatus according to claim 1, wherein said Electronics Module in Single Print Units for prototyping and Print Arrays for production contains the same components comprising:
a Control Hardware Mainboard;
a Single Board Computer;
a Built-In Power Supply;
power button;
a fast-locking keying electrical connector.

4. The apparatus according to claim 1, wherein said Electronics Module also supports RFID, Bluetooth, Bluetooth-LE, IoT interface for logic expansion.

5. The apparatus according to claim 1, wherein said Electronics Module supports a plurality of variations and features in both Single Print Units and Print Units in Print Arrays.

6. The apparatus according to claim 1, wherein said Electronics Module on Single Print Units has an integrated electronics architecture and is not removable.

7. The apparatus according to claim 1, wherein said Electronics Module has local computer power resources for print control only for the Print Unit with which it is associated.

8. The apparatus according to claim 1, wherein said Electronics Module on Single Print Units does not have a defined interface, not being quick-change mounted.

9. The apparatus according to claim 1, wherein said Electronics Module is located in proximate distance to each Print Unit in the Print Array.

10. The apparatus according to claim 1, wherein said Electronics Module may control:
Print Units for engineering materials;
Print Units for high-performance materials;
material feeding systems;
material drying systems;
annealing systems;
vacuum systems;
ultrasonic resin cleaners;
support-material removal systems;
dying, sanding and/or painting systems;
traditional manufacturing equipment;
post-processing automation equipment.

11. The method wherein said Electronics Module has a constant, defined quick-change interface from the Electronics Module to the Print Array Host and a separate quick-change defined interface from the Print Array Host to the Print Unit, comprising:
keying elements;
a slide-in mounting system;
a fast-locking keying electrical connector;
a power plug.

12. The method according to claim 11, wherein said Electronics Module is a slide-out interchangeable metal cabinet subassembly.

13. The method according to claim 11, wherein said Electronics Module can be switched off and removed individually for technical service.

14. The method according to claim 11, wherein said Electronics Module directly controls only the Print Unit it is associated with, having only local computer power resources.

15. The method according to claim 11, wherein said Electronics Module connects to an internal router in the Print Array.

16. The method according to claim 11, wherein said Electronics Module can be operated and visualized via remote connection via IP or local host.

17. The method according to claim 11, wherein said Electronics Module uses handshake protocols to pull Print Unit information.

18. The method according to claim 11, wherein said Electronics Module self-identifies on the Production Network as an individual addressable and controllable print node.

19. The method according to claim 11, wherein said Electronics Module stores machine performance offsets of the Print Unit it is associated with in a removable memory.
